(19) United States
(12) Patent Application Publication
(10) Pub. No.: US 2024/0276553 A1
(43) Pub. Date: Aug. 15, 2024

(54) NETWORK NODE AND METHOD IN A MULTI-TPR COMMUNICATION NETWORK WHERE MINIMUM DISTANCE IS OBTAINED BY ESTABLISHING PATH-LOSS DIFFERENCE BETWEEN UE AND TPRs

(71) Applicant: Telefonaktiebolaget LM Ericsson (publ), Stockholm (SE)

(72) Inventors: Yang Zhang, Sollentuna (SE); Yufeng Zhao, Upplands Väsby (SE); Magnus Finne, Sundbyberg (SE); Weidong Kong, Bromma (SE); Lars O. Mårtensson, Täby (SE)

(21) Appl. No.: 18/567,925

(22) PCT Filed: Jun. 18, 2021
(86) PCT No.: PCT/SE2021/050603

§ 371 Date: Dec. 7, 2023

(51) Int. Cl. H04W 74/0833; H04W 52/24; H04W 52/28; H04W 52/36; H04W 52/40

(52) U.S. Cl. CPC H04W 74/0833; H04W 52/242; H04W 52/283; H04W 52/36; H04W 52/40

(57) ABSTRACT

A method performed by a network node for controlling power in a Random Access (RA) procedure is provided. The RA procedure is from a UE to a first Transmission and reception Point (TRP) in a multi TRP cell in a wireless communications network. For each respective TRP out of a set of TRPs, network node calculates a smallest distance between this TRP and each respective other TRP comprised in the set of TRPs. The set of TRPs are comprised in the multi TRP cell. The network node obtains a minimum distance among the calculated smallest distances. Based on the minimum distance, the network node establishes a path loss difference towards each of the TRPs in the set of TRPs, as experienced by the UE. The network node calculates a target power based on the established path loss difference and a preamble detection sensitivity level. The target power is to be used.

### TECHNICAL FIELD

Embodiments herein relate to a network node and a method therein. In some aspects, they relate to control power in a Random Access (RA) procedure from a User Equipment (UE) to a first Transmission and Reception Point (TRP) in a multi TRP cell of a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

A Random Access (RA) procedure means a sequence of messages, starting with a preamble, between a UE and a base station, also referred to as network node herein, in a Radio Access Network (RAN) in order for the UE to acquire UL synchronization and obtain a specified ID for an upcoming radio access communication.

### PRACH Detector

Physical Random Access Channel (PRACH) preambles in NR are generated from Zadoff-Chu sequences, as described in 3GPP TS 38.211 v15.6.0, “Physical channels and modulation”. A preamble consists of one or more periods of the Zadoff-Chu sequence plus a cyclic prefix.

A typical PRACH detector is described in 3GPP Tdoc R1-1702127, Ericsson, “NR PRACH design”, February 2017. A bandpass filter is followed by a bank of correlators for the configured preamble sequences in the cell. The correlator output for different periods, if more than one period, of the periodic preamble may be combined either coherently or non-coherently. In the former case the complex correlator output from the different periods are summed. In the latter case the power, i.e. the amplitude squared, of the correlator output is summed. Furthermore, the correlator outputs from different receive antennas are added non-coherently.

Once a combined signal is formed from the correlator outputs, a preamble is detected if the power scaled by the estimated noise power for any sample within the possible range of delays in the combined signal exceeds a threshold. The sample with the highest power also gives the estimated time-of-arrival that ideally equals the round-trip time.

The Zadoff-Chu sequences have ideal periodic autocorrelation properties that make it possible to estimate the time-of-arrival with high accuracy as long as the delay of the signal is within the period of the preamble.

To increase the number of available sequences, while keeping a certain level of orthogonality between different preambles derived from each base root sequences, a cyclic shift may be applied over the base root sequence. The value of the cyclic shifts of the root sequences (i.e., base sequences) may be represented by a ZeroCorrelationZoneConfig (N_{cs}) parameter. The N_{cs} value determines the maximum delay that base station can detect and therefore also impacts cell range.

### Multiple-TRP

The 5G system is generally a multi-beam based system. In such a system, one cell can have one or more transmission/reception points (TRPs). The TRPs may be co-sited or spread in a cells coverage area.

The most common deployment is single-TRP cells, where the cell has one sector carrier that represents the resources of the TRP in a cell. Changing the serving cell requires an Radio Resource Configuration (RRC) reconfiguration of the resources, which generates a transmission gap, approximately ˜60-100 ms, and if addressing the primary cell of the connection it introduces a retainability risk. In a multi-TRP cell, when UE moves between the TRPs, it is possible to switch the serving TRP of UE without need of RRC signaling. This because the mobility performed between the TRPs can be handled internally in the cell by lower layers, e.g. MAC layer, or it can be seamless. Combining multiple TRPs into one cell can also simplify the configuration and deployment of a radio network.

With the NR 3GPP specification, it is expected to achieve TRP reselection in a free, seamless and fast way to utilize the TRPs in the network without always requiring Layer 3, e.g. RRC layer, signaling. It is even more important in 5G due to the introduction of new low latency demanding services and the introduction of the RAN higher layer split, i.e. Distributed Unit (DU)/Central Unit (CU), where the RRC control may be more centralized deployed, i.e. with increased delay. A dynamic and smooth multiple-TRP solution would work as a catalysator to enable several different network benefits.

There are many different ways to deploy multi-TRP cell. Dynamic Point Switching (DPS) and Single Frequency Network (SFN) are two of the most common methods. While DPS switch UE to the best TRP, SFN based approach is selected by many vendors as solution for first phase product implementation of Multi-TRP, due to its simplicity and good usage in some scenarios.

If all TRPs in a multi TRP cell share the same PRACH sequence resource, there may arise a PRACH ambiguity issue resulting in an affected PRACH capacity and performance. This will be described below.

### SUMMARY

An object of embodiments herein is to improve the performance of a communications network using multi TRP cells.

According to an aspect of embodiments herein, the object is achieved by a method performed by a network node for controlling power in a Random Access, RA, procedure. The RA procedure is from a User Equipment, UE, to a first Transmission and reception Point, TRP, in a multi TRP cell in a wireless communications network. For each respective TRP out of a set of TRPs, network node calculates a smallest distance between this TRP and each respective other TRP comprised in the set of TRPs. The set of TRPs are comprised in the multi TRP cell. The network node obtains a minimum distance among the calculated smallest distances. Based on the minimum distance, the network node establishes a path loss difference towards each of the TRPs in the set of TRPs, as experienced by the UE. The network node calculates a target power based on the established path loss difference and a preamble detection sensitivity level. The target power is to be used by the UE for transmitting a preamble in the RA procedure to the first TRP.

According to another aspect of embodiments herein, the object is achieved by a network node configured to control power in a Random Access, RA, procedure. The RA procedure is from a User Equipment, UE, to a first Transmission and Reception Point, TRP, in a multi TRP cell in a wireless communications network. The network node is further configured to:
For each respective TRP out of a set of TRPs, calculate a smallest distance between this TRP and each respective other TRP comprised in the set of TRPs, which set of TRPs are arranged to be comprised in the multi TRP cell,
obtain a minimum distance among the calculated smallest distances,
based on the minimum distance, establish a path loss difference towards each of the TRPs in the set of TRPs, as experienced by the UE, and
calculate a target power based on the established path loss difference and a preamble detection sensitivity level. The target power is arranged to be used by the UE for transmitting a preamble in the RA procedure to the first TRP.

Since the network node establishes a path loss difference based on the minimum distance, which path loss difference is towards each of the TRPs in the set of TRPs as experienced by the UE, the network node can calculate a target power based on the established path loss difference and a preamble detection sensitivity level. This results in that the performance of a communications network using multi TRP cells is improved. This is the performance of Random Access is improved, since the method reduces the probability of false detection on Random Access preambles. The preamble detection is a first step in the Random Access flow. Its false detection leads to radio resource and processing resource waste, also worse network Key Performance Indicators (KPI).

### BRIEF DESCRIPTION OF THE DRAWINGS

Examples of embodiments herein are described in more detail with reference to attached drawings in which:

FIG. 1 is a schematic block diagram illustrating prior art.

FIG. 2a-d are schematic block diagrams illustrating prior art.

FIG. 3a-d are schematic block diagrams illustrating prior art.

FIG. 4 is a schematic block diagram illustrating prior art.

FIG. 5 is a schematic block diagram illustrating embodiments of a wireless communications network.

FIG. 6 is a flowchart depicting embodiments of a method in a network node.

FIG. 7 is a schematic block diagram illustrating embodiments herein,

FIG. 8 is a schematic block diagram illustrating embodiments herein,

FIG. 9a-b are schematic block diagrams illustrating embodiments of a network node.

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12-15 are flowcharts illustrating methods implemented in a communication system including a host computer, a base station and a user equipment.

### DETAILED DESCRIPTION

The green text herein will be used in all three applications, you only need to answer to the questions in this text once, then we will copy the text into the other applications.

As a part of developing embodiments herein a problem was identified by the inventors and will first be discussed.

By allocating different Synchronization Signal Block (SSB) Index (ID)s to different TRPs, it is possible to have a TRP specific PRACH preamble resource. However since the number of SSBIDs is very limited, it cannot always work. E.g., below 3 GHz, max 4 SSBIDs cannot manage e.g. 6 TRPs in a cell. Even if it may work in some cases, such TRP specific PRACH resource configuration will need to be planned together with beam management resources, therefore beam related functionality will be limited.

If all TRPs in a cell share the same PRACH sequence resource, there may arise a e PRACH ambiguity issue as will be described below.

### PRACH Ambiguity

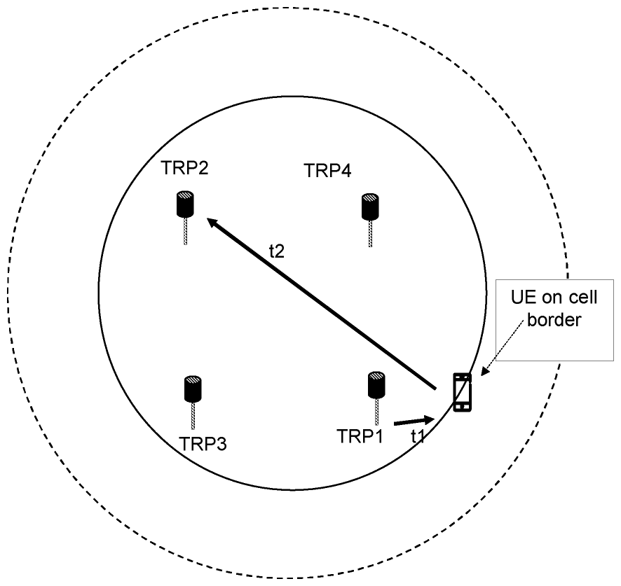

For describe the problem, a UE timing is assumed to synchronize (sync) to a TRP nearby, e.g. TRP1 in FIG. 1. This means that TRP2, that is the TRP most distant from UE, will experience a PRACH delay of t1+t2, if all TRPs are well synchronized. The delay of t1+t2 is since normally a UE synchronizes to the strongest DL signal which is in this case TRP1 i.e., DL delay is t1. While in UL the UE signal arrival time at different TRPs are different, the longest UL delay happened to TRP2 which is t2. Since TRPs are time synchronized, TRP2 will experience a total delay (between DL and UL) of t1+t2 which is the worst case among all TRPs.

For Ncs=0, meaning that only one preamble is created from one root sequence, TRP2 will detect the correct preamble-ID but with a different Timing Advance (TA). However, this should not be a problem, because if there are more than one detection on a certain preamble-ID, only the strongest one is selected which is normally correct.

For Ncs≠0 i.e. more than one preamble is created from one root sequence, which is a common case for not very big cells, (Ncs/L)/df>t1+t2 should be satisfied. t1 is DL propagation delay between the TRP1 and the UE, t2 is UL propagation delay between the UE and the TRP2, UE sync error is ignored here. Otherwise, false detection may occur. This is since an RA preamble will be wrongly detected as another preamble ID by the TRP2. Ncs is zero zone configuration per 3GPP chapter 6.3.3 in 38.211, L is preamble sequence length, df is PRACH signal's subcarrier spacing i.e. 1/df corresponds PRACH symbol length.

In principle, the false detection can be mitigated by applying a bigger Ncs value which corresponds a bigger cell range, the dashed circle in FIG. 1, however such Ncs increase is undesired if PRACH short format is used, because more root sequences are then needed for such multi TRP (mTRP) cells while sequence planning is already very difficult due to the limited number of root sequences. Note that a short format has to be used for those Time Division Duplex (TDD) patterns that contain only 1 UL slot, e.g. in Korea, long format will occupy minimum 2 Midband slots which is not affordable.

### Visualization of Preamble Ambiguity Area

Relating to the difference between cell range and Ncs, Ncs is the parameter on how a root sequence should be reused, the original root sequence is cyclic shifted at interval of Ncs so the biggest cell range (longest tolerable propagation delay) is defined by Ncs zone's time length.

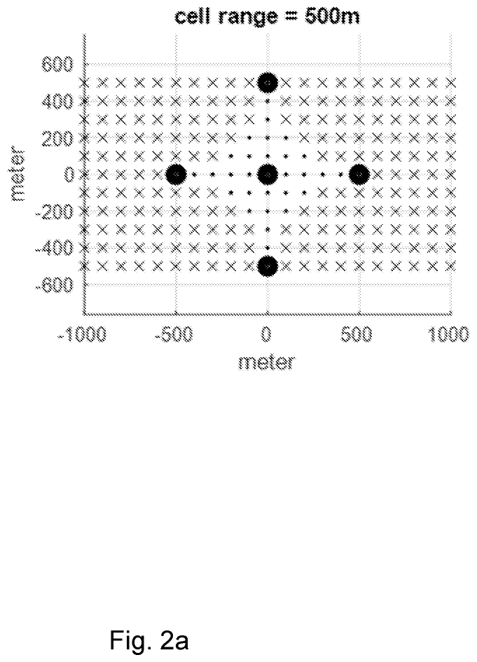

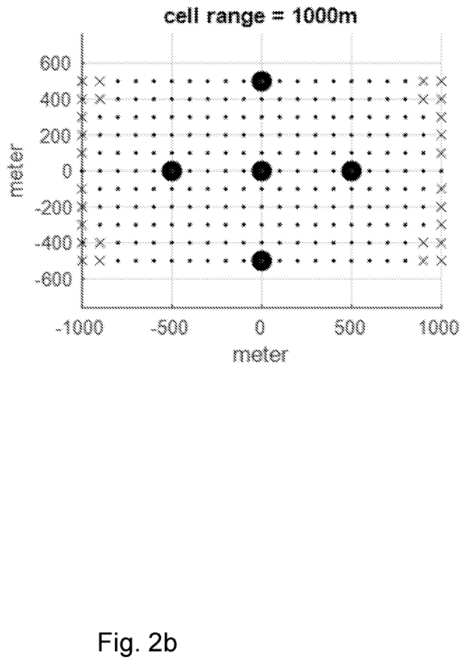

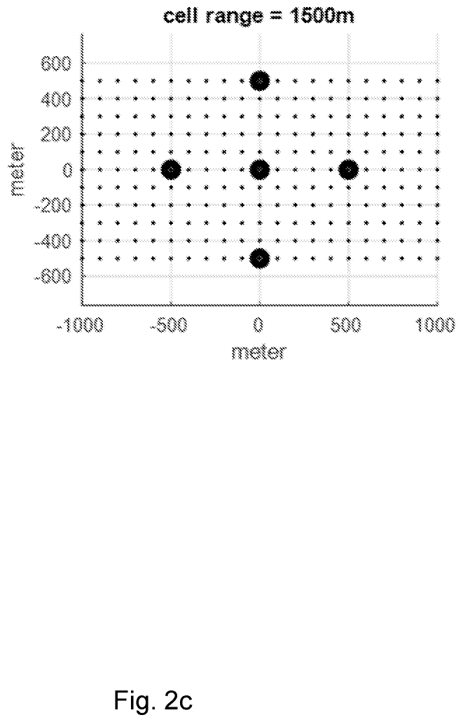

FIGS. 2a-d, illustrates 5 TRPs forming a square with minimum Inter-Site Distance (ISD) of 500 m in four different cell range scenarios, wherein FIG. 2a depicts a cell range of 500 m, FIG. 2b depicts a cell range of 1000 m, FIG. 2c depicts a cell range of 1500 m, and FIG. 2d depicts a cell range of 2000 m. Based on assumption that a UE always synchronizes to the closest TRP, i.e. assuming that the closest TRP is strongest, for each position on a 2D plane, distances towards the closest and furthest TRPs can be calculated so that small dots can be marked if the condition (Ncs/L)/df>t1+t2 can be fulfilled, and that x:s can be marked if the condition (Ncs/L)/df>t1+t2 cannot be fulfilled. Note that the Ncs is not quantized i.e. it changed proportionally with each cell range modification to show the impact. Black big dots denote TRP sites.

From FIG. 2a it can be seen that only a small area close to the centre TRP has no false detections.

From FIG. 2b it can be seen that false detections happen to the area 1000 meter away for the centre TRP.

From FIGS. 2c and d it can be seen that no false detections in the interested coverage area.

In conclusion, it seems that a doubled cell range or Ncs may solve the false detection problem. For example, with a cell range of 1000m (FIG. 2b), there can still be some false detections, at the x:s at −1000m and 1000m, these may be removed if Time Advance (TA) check can be performed properly. Note that doubled Ncs normally means that the number of required root sequences is also doubled.

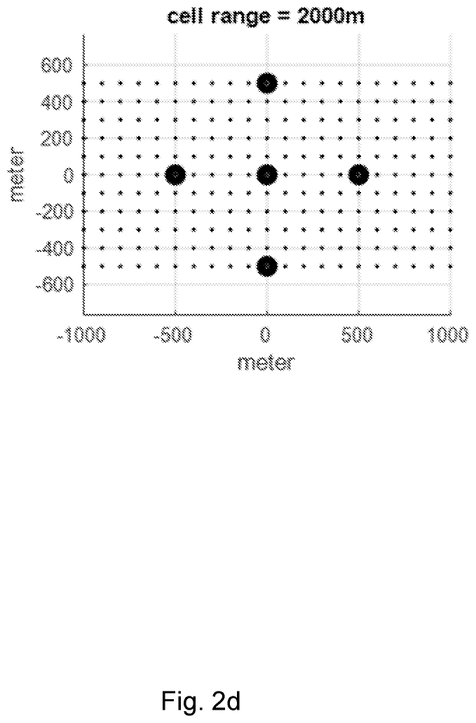

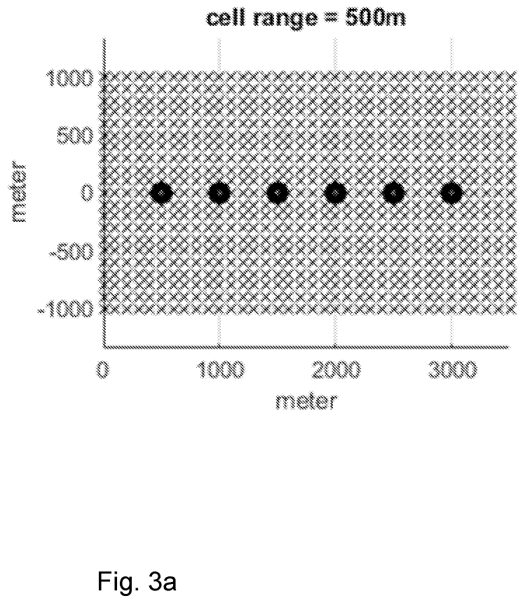

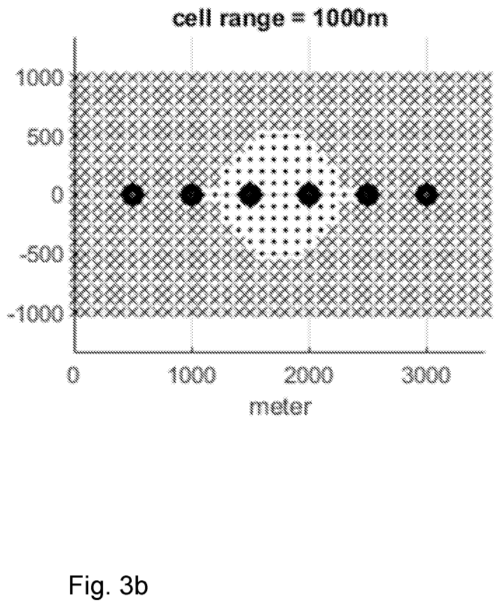

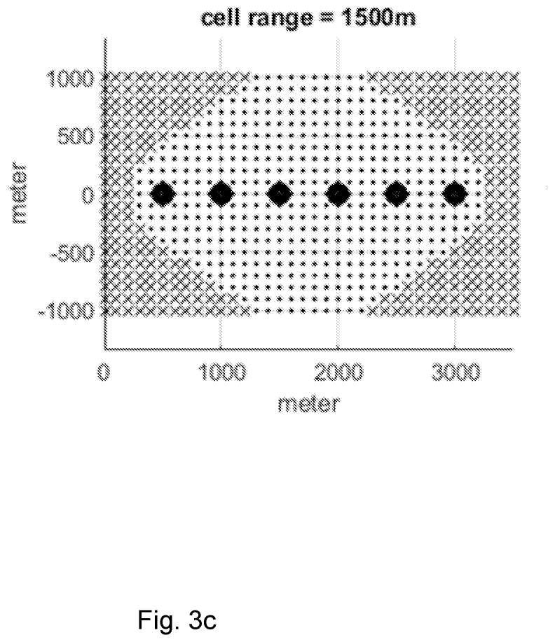

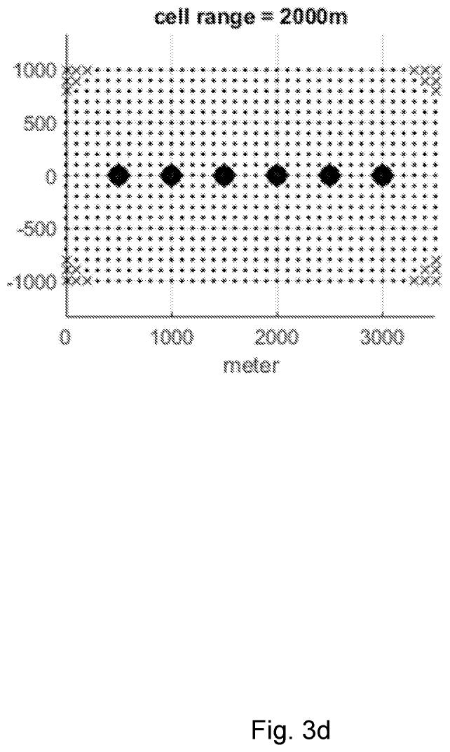

In FIGS. 3a-d, 6 TRPs are located on a straight line at 500 meters spacing in four different cell range scenarios, wherein FIG. 3a depicts a cell range of 500m, FIG. 3b depicts a cell range of 1000m, FIG. 3c depicts a cell range of 1500m, and FIG. 3d depicts a cell range of 2000m. Based on the same assumptions as above, that a UE always synchronizes to the closest TRP, i.e. assuming that the closest TRP is strongest, for each position on a 2D plane, distances towards the closest and furthest TRPs can be calculated so that small dots can be marked if the condition (Ncs/L)/df>t1+t2 can be fulfilled, and that x:s can be marked if the condition (Ncs/L)/df>t1+t2 cannot be fulfilled. For such scenarios, the cell range, or N_{cs}, increase method is not as effective as the scenarios related to FIGS. 2a-d.

From FIG. 3a it can be seen that false detection may happen to all areas . . . .

From FIGS. 3b and c it can be seen that false detection is gradually decreased.

From FIG. 3d it can be seen that false detection becomes acceptable while the cell would need to cover some unintended areas as well.

This means that at least 3 times more root sequences are required, i.e. increasing the cell range from 500m to 1500m, in order to mitigate the problem to an acceptable level.

A conclusion on the approach to increase cell range, or N_{cs}, may be that it may mitigate the false detection issue. However, it may also result in an undesirable larger coverage area or many more root sequences may be needed, roughly proportional to the N_{cs} increase, for a multi-TRP cell.

For the PRACH long format, the cell range, or N_{cs}, increase method may be acceptable, since root sequence resource is less limited. However, the excessive use of root sequences may be undesired unless the method is much simpler that other alternatives.

### A Simple Solution Alternative

One simple way to solve the problem is to select the strongest detected preamble ID to avoid false detections, since false detections are normally weaker. However, this alternative will decrease that PRACH capacity since only one detection may be responded to for each PRACH occasion. As a consequence, missed detections or RA delays are inevitable and may not be acceptable when it comes to capacity requirements, e.g. 1000 concurrent connected users, i.e. RRC connections.

In 3GPP NR SIB1(3GPP TS38.321, TS38.331), preamble Received Target Power (preambleReceivedTargetPower), hereinafter referred to as the target power, is an open loop power control setting, indicating an expected received preamble power at a network node such as a gNB or TRP.

The UE may determine a PRACH transmission power according to:

$${P}_{RA} = min \{ {P}_{max} , {P}_{target} + PL \}$$

where Pₘₐₓ is UE max power, P_{target} is target power, PL is the estimated path loss by UE.

A path loss may be defined as the ratio of the transmit power to the receive power. A path loss model relates the path loss to the distance between the transmitter and the receiver. By combining a link budget with a suitable path loss model, the coverage range of the base station may be estimated.

A Power Ramping Step (PowerRampingStep) defines how much to increase the power if the UE retries to send a preamble. The two parameters target power and ramping step may be tuned so that the received preamble power at gNB should not be stronger than necessary. This normally means that a reasonable low preamble Received Target Power and a not too large ramping step are preferred. The purpose is to make sure that the preamble can be heard by the closest TRP while minimize its received power at other TRPs, so that the TRPs that could potentially false detect the preamble ID cannot receive the preamble.

FIG. 4 depicts different false detection scenarios illustrating the above mentioned ambiguity issue. For the examples depicted in FIG. 4, in the scenario of Case A, TRP2 and TRP3 will potentially false detect the preamble from a UE, wherein a rather small Ncs configuration is applied, while in the scenario of Case B, only TRP3 will false detect the preamble wherein a bigger Ncs configuration is applied. Note that the scenarios of Case A and Case B are just examples, there may be many more possible cases.

A rather small Ncs configuration means that DL+UL propagation delay between a UE and a certain TRP cannot be bigger than the time length defined by Ncs, otherwise the TRP will detect a false preamble, provided that the signal is strong enough to be detected. Compared with small Ncs value, a big Ncs means that in a TRP cell, false detection less is likely to happen while more sequence resource is required.

Embodiments herein solve the above-mentioned problems by providing a method for controlling power in a RA procedure from a UE to a TRP in a multi TRP cell, and in some embodiments a method for tuning RA power control.

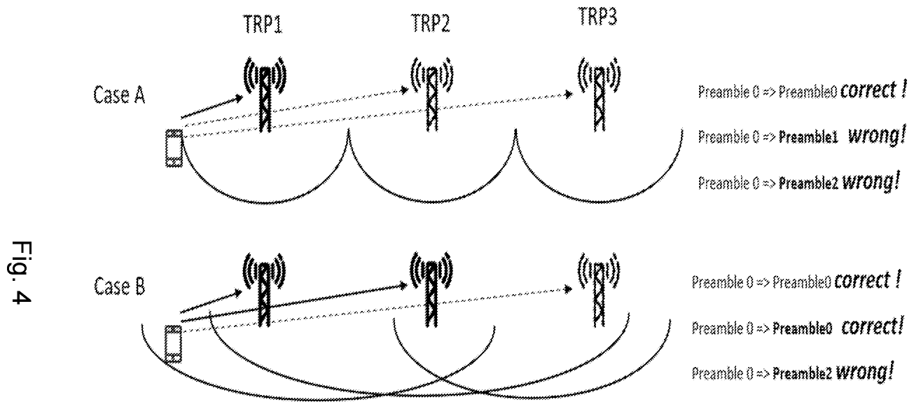

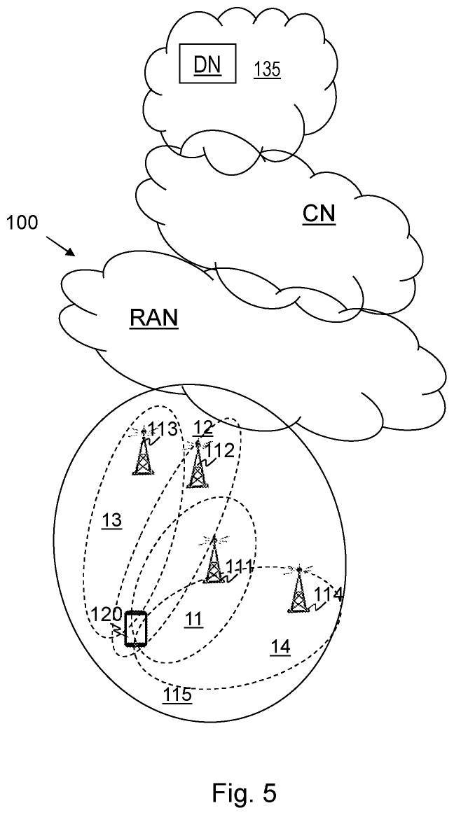

FIG. 5 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., a network node 110. Further a number of TRPs such as e.g. a first TRP 111, a second TRP 112, a third TRP 113 and a fourth TRP 114, also referred to as the TRPs 111, 112, 113, 114. The TRPs may be associated to the network node 110. The TRPs 111, 112, 113, 114 and in some embodiments the network node 110 provide radio coverage in a number of coverage areas comprised in a multi TRP cell 115, such as a coverage area 11 provided by the first TRP 111, a coverage area 12 provided by the second TRP 112, a coverage area 13 provided by the third TRP 113, and a coverage area 14 provided by the third TRP 114. The network node 110 may control the multi TRP cell 115, and the TRPs 111, 112, 113, 114. The network node 110 may be a TRP, e.g. the TRP 111.

In an example scenario, the first TRP 111 is the TRP that is closest to a UE 120 and may therefore be an intended TRP for a UE 120 in a RA process in the multi TRP cell 115 according to embodiments herein.

The network node 110, and the TRPs 111, 112, 113, 114 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), agNB, a base transceiver station, a radio remote unit, an Access Point Base Station, a base station router, a transmission arrangement of a radio base station, a stand-alone access point or any other network unit capable of communicating with a wireless device within the service area served by the network node 110 depending e.g. on the first radio access technology and terminology used. The radio network node 110 may be referred to as a serving radio network node and communicates with the UE 120 with Downlink (DL) transmissions to the UE 120 and Uplink (UL) transmissions from the UE 120.

In the wireless communication network 100, one or more UEs operate, such as e.g. the UE 120. The UE 120 may also referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

Methods herein may be performed by the network node 110. As an alternative, a Distributed Node (DN) and functionality, e.g. comprised in a cloud 135 as shown in FIG. 5, may be used for performing or partly performing the methods herein.

Embodiments herein e.g. provide methods that may be used to tune preamble power and its ramp up, e.g. in order to avoid PRACH ambiguity in a multi-TRP deployment and maintain PRACH capacity.

A number of embodiments will now be described, some of which may be seen as alternatives, while some may be used in combination.

According to an example scenario of a provided method for tuning of target power and power ramping so that a preamble can be detected by only the intended TRPs. The method e.g. involves:

For each TRP in a set of TRPs 112, 113, 114 in a multi TRP cell, find out the smallest distance, between this TRP and any other TRPs that can potentially have ambiguity problem.

Iterate the above procedure over all TRPs 112, 113, 114 and the minimum value among all the calculated smallest distances is obtained.

Based on the minimum distance, calculate path loss differences towards different TRPs 112, 113, 114 which is experienced by the UE 120.

Then Calculate a target power based on the calculated path loss and sensitivity.

The target power is to be used by the UE 120 when transmitting a preamble in an RA procedure to one or more intended TRPs.

Advantages of embodiments herein e.g. comprises that the RA KPI is improve, and capacity impact due to false detections is mitigated in multi-TRP deployments. Further, easier Random Access Channel (RACH) related cell optimization and/or planning is also provided.

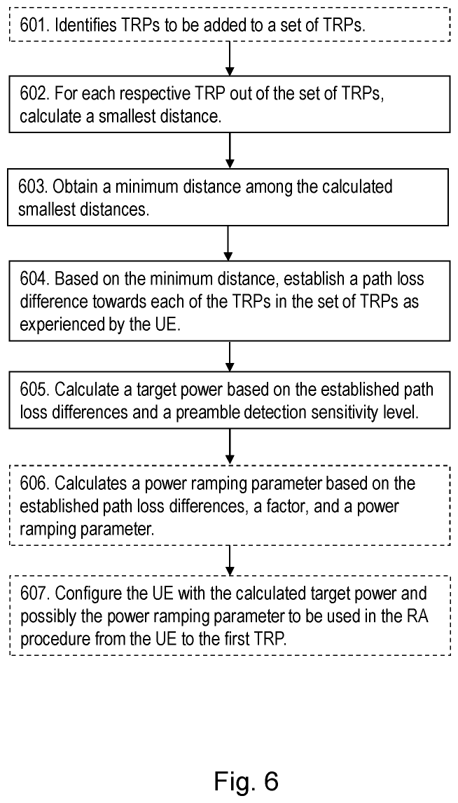

FIG. 6 shows example embodiments of a method performed by the network node 110 for controlling power in an RA procedure. The RA procedure is from the UE 120 to the first TRP 111 in the multi TRP cell 115 in the wireless communications network 100.

In some embodiments, the method is performed to avoid PRACH ambiguity for TRPs in the set of TRPs 112, 113, 114, e.g. sharing a same PRACH sequence resource in the RA procedure from the UE 120 to the first TRP 111.

In an example scenario as mentioned above, the first TRP 111 may be the TRP that is closest to a UE 120 and may therefore be an intended TRP for a UE 120 in the RA process according to embodiments herein. It should be noted that the intended TRP may comprise multiple intended TRPs for the UE 120 in the RA process.

In the method, a calculating of target power and in some embodiments power ramping according to embodiments herein, will result in that that an RA preamble sent by the UE 120 may only be detected by the intended TRPs, and false detections e.g. by TRPs far away from the UE 120 will be mitigated.

The method comprises the following actions, which actions may be taken in any suitable order. Optional actions are referred to as dashed boxes in FIG. 6.

In the example scenario the UE 120 is about to communicate in the wireless communications network and requires starting an RA process.

### Action 601

In some embodiments, the network node 110 identifies TRPs to be added to the set of TRPs. These TRPs comprises TRPs that risk to false detect the preamble sent by the UE 120 in the RA.

The intended TRP 111 is not part of the TRP false detect list. The intended TRP may be an iteration over all TRPs. An example of a purpose of the method according to some embodiments, is to obtain an optimum configuration, relating to target power and ramping step for the multi TRP cell 115, i.e., applicable to all TRPs, such process may be performed offline.

The network node 110 identifies the TRPs among the TRPs in the multi TRP cell 115.

The identifying may be based on an Ncs of the TRPs in the multi TRP cell 115. This is e.g. since the Ncs value directly impacts at what distance a false detection may happen therefore a cell with big Ncs value has less chance for false detections As an alternative, the identifying may be based on a cell range configuration of the TRPs in the multi TRP cell 115. This is e.g. since the cell range may be a parameter that directly or indirectly controls Ncs optimization. In some deployments the cell range is configured by network operators and the Ncs may be derived from a configured cell range directly or indirectly.

The set of TRPs comprises TRPs that are running a risk to false detect a preamble from the UE 120. Such preambles, risking to be false detected, may e.g. be the preambles that the UE 120 has transmitted in the RA process. The set of TRPs may e.g. be collected in a false list.

The first TRP 111 and the TRPs in the set of TRPs 112, 113, 114 are comprised in the multi TRP cell 115. The set of TRPs 112, 113, 114 may be referred to as a TRP false list.

### Action 602

For each respective TRP out of the set of TRPs 112, 113, 114, the network node 110 calculates a smallest distance. The smallest distance refers to the smallest distance between this TRP 111 and each respective other TRP comprised in the set of TRPs 112, 113, 114. The smallest distance is needed because it finds the closest TRP's false detection and may then solve further TRPs as well.

### Action 603

In the example scenario illustrated in FIG. 5 this means:

For the second TRP 112 the smallest distance out of: The distance between the second TRP 112 and the third TRP 113, and the distance between the second TRP 112 and the fourth TRP 113. The underlined is the smallest distance.

For the third TRP 113 the smallest distance out of: The distance between the third TRP 113 and the second TRP 112, and the distance between the third TRP 113 and the fourth TRP 114. The underlined is the smallest distance.

For the fourth TRP 114 the smallest distance out of: The distance between the fourth TRP 114 and the second TRP 112, and the distance between the fourth TRP 114 and the third TRP 113. The underlined is the smallest distance.

Since a smallest distance for each respective TRP out of the set of TRPs 112, 113, 114 has been calculated, the network node 110 has obtained a set of smallest distance relating to the respective TRPs out of the set of TRPs 112, 113, 114. As concluded from the above example scenario:

For the second TRP 112 the smallest distance is to the third TRP 113.

For the third TRP 113 the smallest distance is to the second TRP 112.

For the fourth TRP 114 the smallest distance to the second TR 111.

The network node 110 obtains a minimum distance among the calculated smallest distances. This means that the minimum distance is identified from the set of smallest distance relating to the respective TRPs 112, 113, 114. This may be performed to try to find out a distance that has false detection risk so the target power can be optimized for that distance. I.e. a TPR more distant than this distance ideally should not “hear” the UE 120 signal.

As concluded from the above example scenario, the minimum distance among the calculated smallest distances is the distance between the second TRP 112 and the third TRP 113.

### Action 604

Based on the minimum distance, the network node 110 establishes a path loss difference towards each of the TRPs in the set of TRPs 112, 113, 114, as experienced by the UE 120. The

### Action 605

The network node 110 then calculates a target power based on the established path loss differences and a preamble detection sensitivity level. The path loss difference is in an ideal example secure that only the closest TRP can “hear” the UE signal. The target power may e.g. be an expected preamble power as received by the first TRP 111. The target power is to be used by the UE 120 for transmitting a preamble in the RA procedure.

An advantage with the calculated target power according to embodiments herein is that it in most cases the TRPs 112, 113, 114 that potentially can false detect the preamble will not be able to receive a strong enough signal for detection, so false detection is avoided.

### Action 606

In some embodiments, the network node 110 further calculates a power ramping parameter. This calculation is based on the established path loss differences, a factor, and a power ramping parameter according to a regular system default value. The factor is determined based on historical statistics relating to power ramping, such as e.g. a power ramping success rate.

An advantage with the calculated power ramping parameter according to embodiments herein is that a proper power ramping makes the UE 120 ramping up power in a conservative way so that preamble re-transmission in most cases will not cause false detection either.

### Action 607

The network node 110 may then configure the UE 120 with the calculated target power to be used in the RA procedure from the UE 120 to the first TRP 111.

In some embodiments, the network node 110 further configures the UE 120 with the calculated power ramping parameter to be used in the RA procedure from the UE 120 to the first 111.

In this way the UE 120 may use the calculated target power and power ramping parameter in an efficient way.

The above embodiments will now be further explained and exemplified below. The embodiments below may be combined with any suitable embodiment above.

Below, an example of a calculation of a proper target power is described. In this example, the first TRP 111 is referred to as TRP1, the second TRP 112 is referred to as TRP2, and the third TRP 113 is referred to as TRP3.

Based on Ncs or cell range configuration, for each TRP TRP(i) in a mTRP cell, find out the set of TRPs 112, 113, 114 e.g. as a TRP list TRPfalselist(i) that potentially can false detect an RA preamble from the UE 120 in the TRP's coverage.

For example, in Case A of FIG. 7,

$$TRPfalselist ( 1 ) = \{ TRP 2 , TRP 3 \}$$

while in Case B of FIG. 7,

$$TRPfalselist ( 1 ) = \{ TRP 3 \}$$

This is related to Action 601 described above.

The network node 110 then calculates distances between TRP(i) and TRPs in TRPfalselist(i), and smallest value of the distance, referred to as the smallest distance, is denoted as:

$$d\_min ( i ) = MIN \{ DISTANCE ( TRP ( i ) , TRPfalselist ( i ) ) \}$$

This is related to Action 602 described above.

For all TRPs, the network node 110 finds out the minimum value of d_min(i), referred to as the minimum distance,
Dₘᵢₙ=MIN(d_min(i)), the purpose is to obtain a minimum distance which may potentially cause preamble ambiguity in the target mTRP cell 115.

This is related to Action 603 described above.

The path loss difference PL(Dₘᵢₙ) caused by the minimum distance, Dₘᵢₙ, is then calculated based on the following:

$$PL ( {D}_{min} ) = PL ( {D}_{min} - d ) - PL ( d )$$

where d is typical TRP coverage radius in the target mTRP cell. Take Case B in FIG. 7 for example, wherein the minimum distance, Dₘᵢₙ, corresponds to the distance between TRP1 and TRP3, therefore the path loss different is calculated as PL3-PL1, as illustrated by FIG. 8, while the UE 120 is on the border of the TRP1's actual coverage and located in between TRP1 and TRP3.

This is related to Action 604 described above.

Based on the known preamble detection sensitivity level, Pd, e.g. −114 dBm, and the established pathloss difference, PL(Dₘᵢₙ), assuming that PL(Dₘᵢₙ) is a positive value, the target power P_{target} may calculated as:

$${P}_{target} = Pd + alfa \cdot PL ( {D}_{min} )$$

where alfa is a factor which ranges [0,1], a typical value may be 0.3, which may be tuned in field, so that the expected preamble power is 0.3·PL(Dₘᵢₙ) dBm above sensitivity level at the target TRP 111, while still 0.7·PL(Dₘᵢₙ) dBm below the sensitivity at the TRPs 112, 113, 114 that potentially have ambiguity problems.

This is related to Action 605 described above.

The power ramping parameter, also referred to as a power Ramping Step (powerRampingStep) may be calculated as:

$$Δ P = Max \{ Δ {P}_{min} , Min \{ beta \cdot PL ( {D}_{min} ) , Δ {P}_{0} \} \}$$

ΔPₘᵢₙ is a configured minimum ramping step to secure that RA re-attempts can be successful in the end, i.e. to avoid a too small step is used, an example value is 2 dB.
where beta is a factor ranges [0,1], ΔP₀ is a regular system default value which is currently 4 dB, but may be changed. A typical value of beta is 0.5, it may be tuned in field based on historical statistics including but not limited to RA related statistics, e.g. number of ramp-ups before a successful connection, which means that a ramping step is 50% smaller than PL(Dₘᵢₙ),—to avoid any detection at unintended TRPs 112, 113, 114 when the UE 120 ramps up its transmission power. OK?.

This is related to Action 606 described above.

The provided method according to embodiments herein reduces unnecessary preamble presences in neighbor TRPs such as the TRPs in the set of TRPs 112, 113, 114.

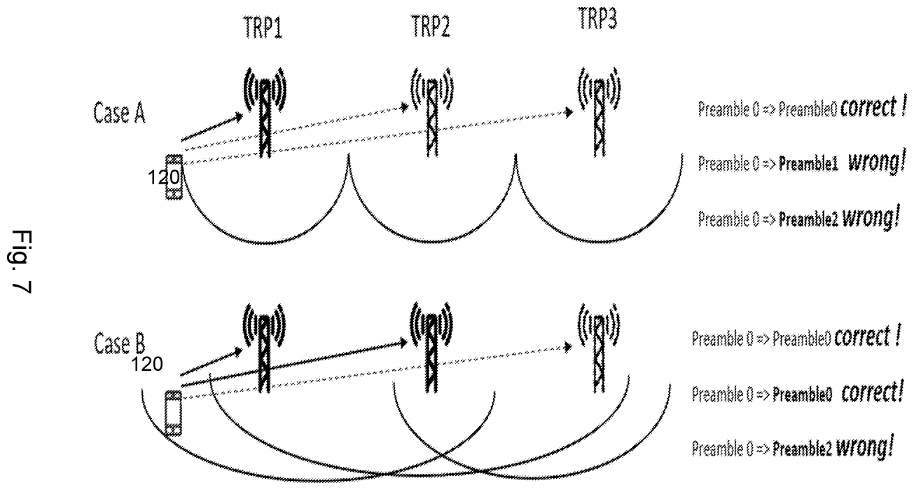

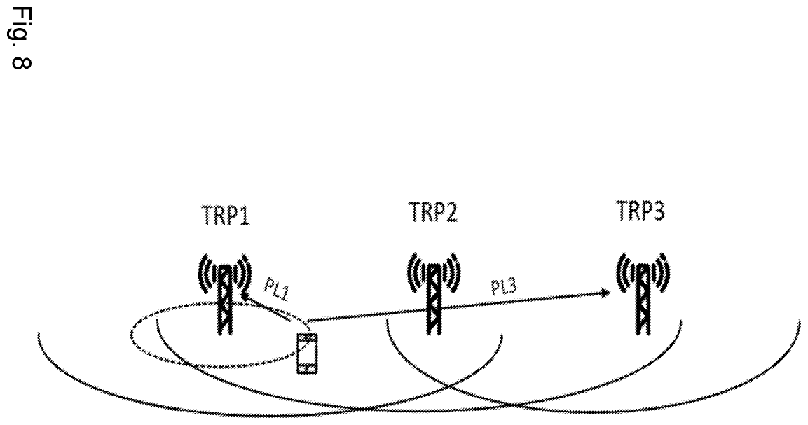

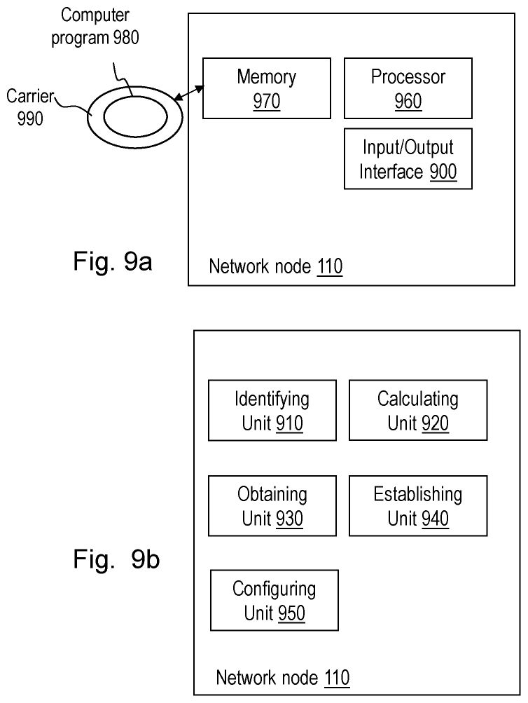

To perform the method actions above, the network node 110 is configured to control the power in a RA procedure from the UE 120 to the first TRP 111 in the multi TRP cell 115 in the wireless communications network 100. The network node 110 may comprise an arrangement depicted in FIGS. 9a and 9b.

The network node 110 may comprise an input and output interface 900 configured to communicate with network nodes such as the TRPs 111, 112, 113, 114. The input and output interface 900 may comprise a wireless receiver (not shown) and a wireless transmitter (not shown).

In some embodiments, the network node 110 is further configured to, e.g. by means of an identifying unit 910 comprised in the network node 110, identify the TRPs to be added to the set of TRPs, among the TRPs in the multi TRP cell 115, based on any one out of: An Ncs of the TRPs in the multi TRP cell 115 or a cell range configuration of the TRPs in the multi TRP cell 115. The set of TRPs is adapted to comprise TRPs running a risk to false detect a preamble from the UE 120.

The network node 110 is further configured to, for each respective TRP out of a set of TRPs 112, 113, 114, calculate a smallest distance between this TRP 111 and each respective other TRP comprised in the set of TRPs 112, 113, 114, e.g. by means of a calculating unit 920 comprised in the network node 110. The set of TRPs 112, 113, 114 are arranged to be comprised in the multi TRP cell 115.

The network node 110 is further configured to, obtain a minimum distance among the calculated smallest distances, e.g. by means of an obtaining unit 930 comprised in the network node 110.

The network node 110 is further configured to, based on the minimum distance, establish a path loss difference towards each of the TRPs in the set of TRPs 112, 113, 114, as experienced by the UE 120, e.g. by means of an establishing unit 940 comprised in the network node 110.

The network node 110 may further be configured to, calculate a target power based on the established path loss difference and a preamble detection sensitivity level, which target power is arranged to be used by the UE 120 for transmitting a preamble in the RA procedure to the first TRP 111 e.g., by means of the calculating unit 920 comprised in the network node 110.

The network node 110 may further be configured to calculate a power ramping parameter based on the established path loss difference, a factor, and a power ramping parameter according to a regular system default value, e.g., by means of the calculating unit 920 comprised in the network node 110. The factor is adapted to be determined based on historical statistics relating to power ramping.

The network node 110 may further be configured to configure the UE 120 with the calculated target power to be used in the RA procedure from the UE 120 to the first TRP 111, e.g., by means of a configuring unit 950 comprised in the network node 110.

The network node 110 may further be configured to to configure the UE 120 with the calculated power ramping parameter to be used in the RA procedure from the UE 120 to the first TRP 111, e.g., by means of the configuring unit 950 comprised in the network node 110.

In some embodiments, the network node 110 is further configured to avoid PRACH ambiguity for TRPs in the set of TRPs 112, 113, 114, sharing a same PRACH sequence resource in the RA procedure from the UE 120 to the first 111 TRP.

The embodiments herein may be implemented through a respective processor or one or more processors, such as the processor 960 of a processing circuitry in the network node 110 depicted in FIG. 9a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 970 comprising one or more memory units. The memory 970 comprises instructions executable by the processor in the network node 110. The memory 970 is arranged to be used to store e.g., information, indications, data, configurations, and applications to perform the methods herein when being executed in the network node 110.

In some embodiments, a computer program 980 comprises instructions, which when executed by the respective at least one processor 960, cause the at least one processor of the network node 110 to perform the actions above.

In some embodiments, a respective carrier 990 comprises the respective computer program 980, wherein the carrier 990 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the UE 120, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

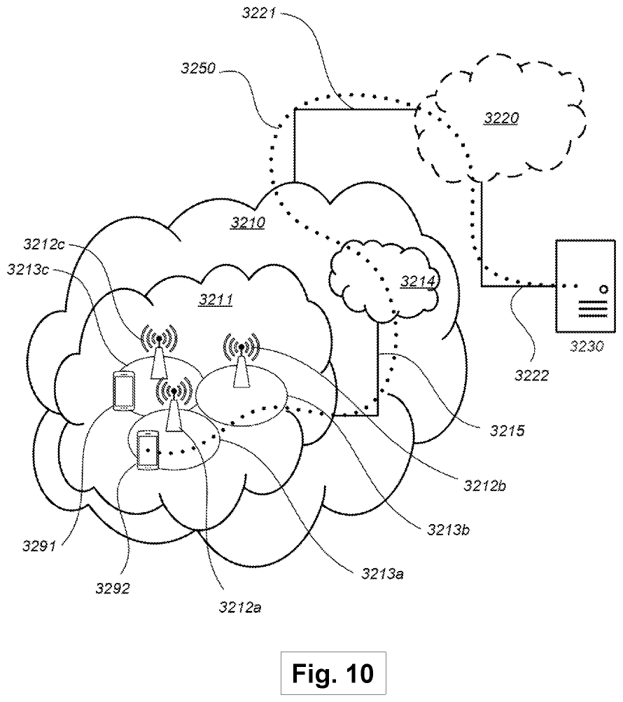

With reference to FIG. 10, in accordance with an embodiment, a communication system includes a telecommunication network 3210 such as the containerized applications network 100, e.g., an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

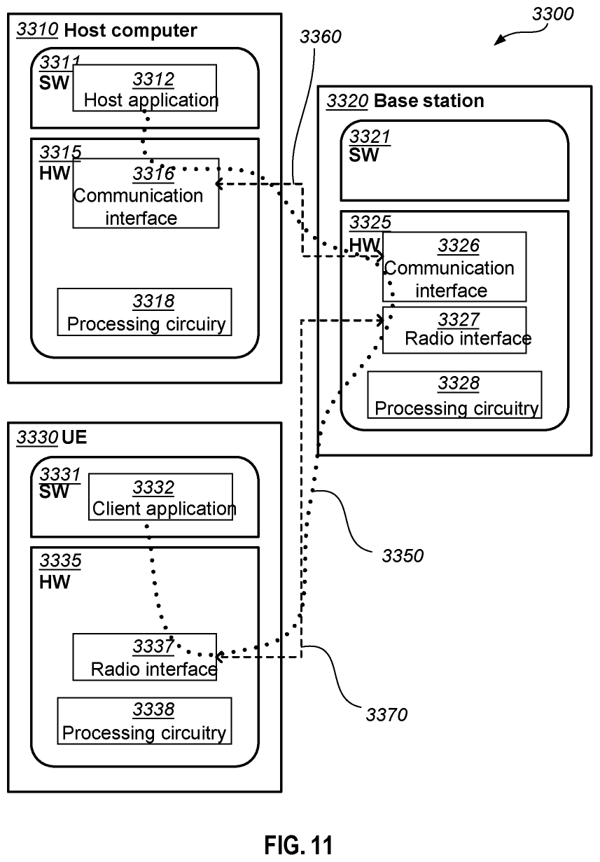

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

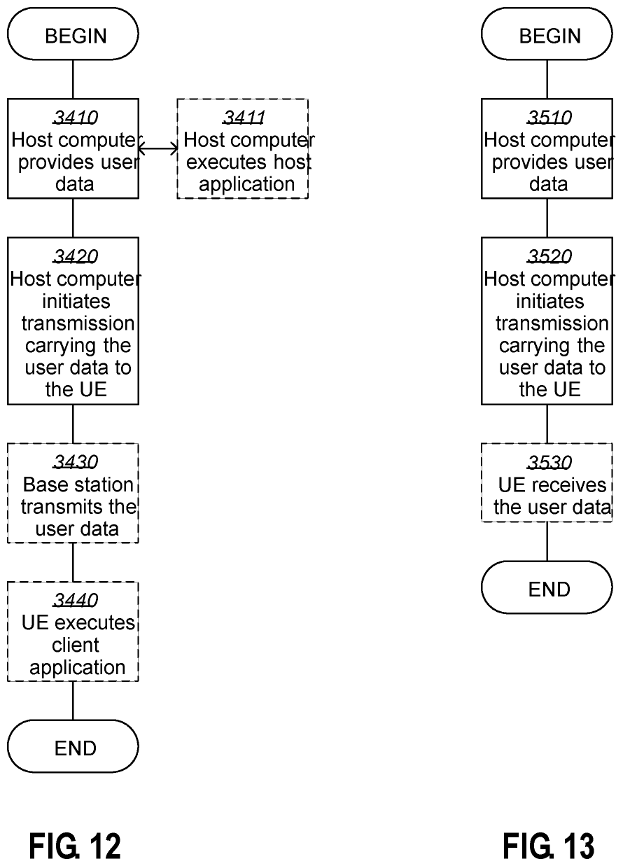

FIG. 12 is a flowchart illustrating a method implemented in a communication system, in accordance with one embodiment. The communication system includes a host computer, a base station such as the network node 112, and a UE such as the UE 120, which may be those described with reference to FIG. 10 and FIG. 11. For simplicity of the present disclosure, only drawing references to FIG. 12 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

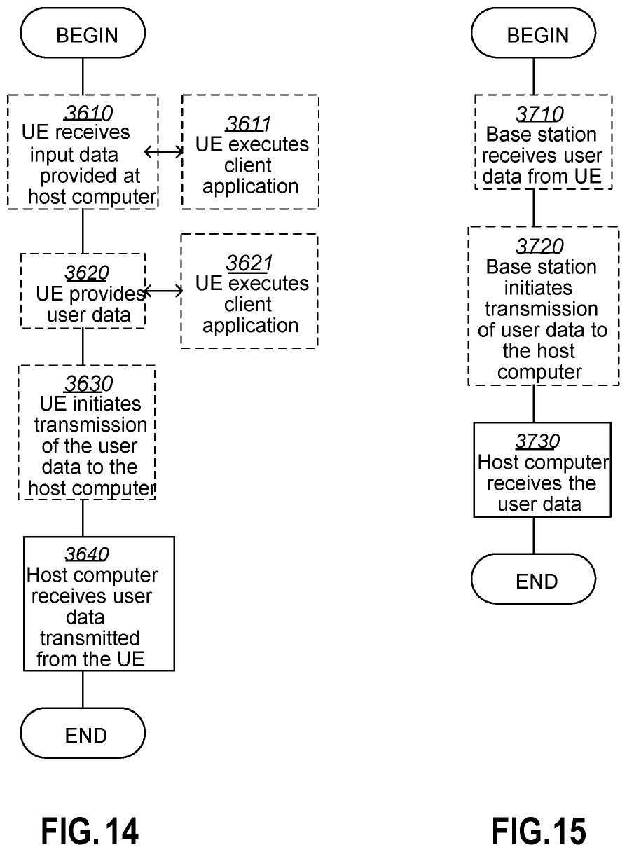

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 14 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 10 and FIG. 11. For simplicity of the present disclosure, only drawing references to FIG. 15 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a network node for controlling power in a Random Access, RA, procedure from a User Equipment, UE, to a first Transmission and reception Point, TRP, in a multi TRP cell in a wireless communications network, the method comprising:
for each respective TRP out of a set of TRPs, calculating a smallest distance between this TRP and each respective other TRP comprised in the set of TRPs, which set of TRPs are comprised in the multi TRP cell, obtaining a minimum distance among the calculated smallest distances,
based on the minimum distance, establishing a path loss difference towards each of the TRPs in the set of TRPs, as experienced by the UE, and
calculating a target power based on the established path loss difference and a preamble detection sensitivity level, which target power is to be used by the UE for transmitting a preamble in the RA procedure.

2. The method according to claim 1, further comprising:
calculating a power ramping parameter based on, the established path loss difference, a factor and a power ramping parameter according to a regular system default value, which factor is determined based on historical statistics relating to power ramping.

3. The method according to claim 1, further comprising:
identifying the TRPs to be added to the set of TRPs, among the TRPs in the multi TRP cell, based on any one out of:
a Zero Correlation Zone Configuration, Ncs, of the TRPs in the multi TRP cell or
a cell range configuration of the TRPs in the multi TRP cell, which set of TRPs comprises TRPs running a risk to false detect a preamble from the UE.

4. The method according to claim 1, further comprising:
configuring the UE with the calculated target power to be used in the RA procedure from the UE to the first TRP.

5. The method according to claim 4, wherein the configuring of the UE with the calculated target power further comprises configuring the UE with the calculated power ramping parameter to be used in the RA procedure from the UE to the first.

6. The method according to claim 1, wherein
the method is performed to avoid Physical Random Access Channel, PRACH, ambiguity for TRPs in the set of TRPs.

7. A computer program comprising instructions, which when executed by a processor, causes the processor to perform actions comprising:
for each respective Transmission and Reception Point, TRP, out of a set of TRPs, calculate a smallest distance between this TRP and each respective other TRP comprised in the set of TRPs, which set of TRPs are arranged to be comprised in the multi TRP cell,
obtain a minimum distance among the calculated smallest distances,
based on the minimum distance, establish a path loss difference towards each of the TRPs in the set of TRPs, as experienced by a User Equipment, UE, and
calculate a target power based on the established path loss difference and a preamble detection sensitivity level, which target power is arranged to be used by the UE for transmitting a preamble in a Random Access, RA, procedure to the first TRP.

8. (canceled)

9. A network node configured to control power in a Random Access, RA, procedure from a User Equipment, UE, to a first Transmission and Reception Point, TRP, in a multi TRP cell in a wireless communications network, the network node further being configured to:
for each respective TRP out of a set of TRPs, calculate a smallest distance between this TRP and each respective other TRP comprised in the set of TRPs, which set of TRPs are arranged to be comprised in the multi TRP cell,
obtain a minimum distance among the calculated smallest distances, based on the minimum distance, establish a path loss difference towards each of the TRPs in the set of TRPs, as experienced by the UE, and
calculate a target power based on the established path loss difference and a preamble detection sensitivity level, which target power is arranged to be used by the UE for transmitting a preamble in the RA procedure to the first TRP.

10. The network node according to claim 9 further configured to:
calculate a power ramping parameter based on the established path loss difference, a factor, and a power ramping parameter according to a regular system default value, which factor is adapted to be determined based on historical statistics relating to power ramping.

11. The network node according to claim 9 further configured to:
identify the TRPs to be added to the set of TRPs, among the TRPs in the multi TRP cell, based on any one out of:
a Zero Correlation Zone Configuration, Ncs, of the TRPs in the multi TRP cell or
a cell range configuration of the TRPs in the multi TRP cell, which set of TRPs is adapted to comprise TRPs running a risk to false detect a preamble from the UE.

12. The network node according to claim 9 further configured to:
configure the UE with the calculated target power to be used in the RA procedure from the UE to the first TRP.

13. The network node according to claim 12, further configured to configure the UE with the calculated power ramping parameter to be used in the RA procedure from the UE to the first TRP.

14. The network node according to claim 9, further configured to avoid Physical Random Access Channel, PRACH, ambiguity for TRPs in the set of TRPs.
